(19) United States
(12) Patent Application Publication
(10) Pub. No.: US 2009/0238422 A1
(43) Pub. Date: Sep. 24, 2009

(54) COMMUNICATIVE CAD SYSTEM FOR ASSISTING BREAST IMAGING DIAGNOSIS

(75) Inventors: Heidi Zhang, Los Gatos, CA (US); Patrick Heffernan, Los Gatos, CA (US)

Correspondence Address: Three Palm Software LLC, 367 Penn Way, Los Gatos, CA, 95032, UNITED STATES, 408 356 3240, heidiz@threepalmsoft.com

(73) Assignee: Three Palm Software, Los Gatos, CA (US)

(21) Appl. No.: 12/120,084

(22) Filed: May 13, 2008

Related U.S. Application Data
(63) Continuation of application No. US60/930132, filed on May 15, 2007.

(51) Int. Cl. G06K 9/00

(52) U.S. Cl. 382/128

(57) ABSTRACT

This invention provides a computational intelligence method and system that can be used interactively by a radiologist in a “concurrent read” model to aid diagnosis from medical images. In particular, the invention operates more like a very patient, indefatigable knowledge accumulating and communicating companion for the radiologist, rather than a second “expert” whose advice is sought after a normal review. The system works interactively with the radiologist during image reading, prompting areas to review in more detail, providing computer generated features and interpretation, and suggesting potential diagnoses for areas of suspicion that are identified either by the machine or the human. In addition, the human can obtain more information from the system—the radiologist can query as to why a particular region is highlighted, or why a particular diagnosis is postulated for an area. Conversely, the system learns from the human—the radiologist identifies areas that should be marked, and updates the computer's knowledge of what the diagnosis should be for that area.

### CROSS-REFERENCE TO RELATED APPLICATIONS

### U.S. Patent Documents

1. U.S. Pat. No. 6,630,937 October 2003 Kallergi et al. “Workstation interface for use in digital mammography and associated method”
2. U.S. Pat. No. 6,944,330 September 2005 Novak et al. “Interactive computer-aided diagnosis method and system for assisting diagnosis of lung nodules”
3. U.S. Pat. No. 7,184,582 February 2007 Giger et al. “Method, system and computer readable medium for an intelligent search workstation for computer assisted interpretation of medical images”

### OTHER PUBLICATIONS

4. Laszlo Tabar and Peter B. Dean “Teaching Atlas of Mammography”, Thieme Stuttgart, New York 2001
5. Joshua J. Fenton et al. “Influence of Computer-Aided Detection on Performance of Screening Mammography” New England Journal of Medicine, Volume 356:1399-1409, Apr. 5, 2007, Number 14

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The present invention relates generally to the field of medical imaging systems. Particularly, the present invention relates to a method and apparatus for a communicative computational intelligence system for assisting breast imaging diagnosis in conjunction with mammography CAD (Computer-aided diagnosis) server and digital mammography workstation.

The U.S. patent Classification Definitions: 382/128 (class 382, Image Analysis, subclass 128 Biomedical applications); 378/37 (class 378, X-Ray or Gamma Ray System or Devices, subclass 37 Mammography).

Early detection of breast cancer is the goal of mammography screening. With the rapid transition from film to digital acquisition and reading, more radiologists can benefit from advanced image processing and computational intelligence techniques if they can be applied to this task. The conventional approach is for such techniques to be embedded in a Computer Aided Detection (CAD) system that essentially operates off-line, and generates reports that can be viewed by a radiologist after un-aided reading (i.e., in a “second read” model). The off-line CAD reports usually provide only detection location coordinates and limited measurement and cancer likelihood information—but only at pre-defined regions or volumes of interest (ROI or VOI, see reference 1 and reference 2) that were determined during the CAD pre-processing. This constraint on the computer generated information that can be communicated between computer and human reader sometimes decreases the effective performance of the CAD system as well as that of human readers who use the CAD system (see reference 5).

### BRIEF SUMMARY OF THE INVENTION

This invention provides a computational intelligence (CI) method and apparatus to overcome the limitations from current CAD systems by providing a system that can be used interactively by a radiologist (i.e., in more of a “concurrent read” model). In particular, the invention operates more like a very patient, indefatigable knowledge accumulating and communicating companion for the radiologist, rather than a second “expert” whose advice is sought after a normal review.

The system works interactively with the radiologist during image reading, prompting areas to review in more detail, providing computer generated features and interpretation, and suggesting potential diagnoses for areas of suspicion that are identified either by the machine or the human. In addition, the human can obtain more information from the system—the radiologist can query as to why a particular region is highlighted, or why a particular diagnosis is postulated for an area. Conversely, the system learns from the human—the radiologist identifies areas that should be marked, and updates the computer's knowledge of what the diagnosis should be for that area.

### BRIEF DESCRIPTION OF THE SEVERAL VIEWS OF THE DRAWING

FIG. 1 provides overview to the communicative CAD system.

FIG. 2 provides the reading workflow with the system.

FIG. 3 provides two mammography image layout (hanging protocol) examples.

FIG. 4 provides the viewing workflow with the system.

FIG. 5 provides the interpretation workflow with the system.

FIG. 6 provides the overall viewing flowchart and its demonstration.

FIG. 7 provides the systematic (perception) viewing flowchart and its demonstration.

FIG. 8 provides all pixels viewing and its demonstration.

FIG. 9 provides interpretation example for a mass finding.

FIG. 10 provides CI processing example for mammography.

### DETAILED DESCRIPTION OF THE INVENTION

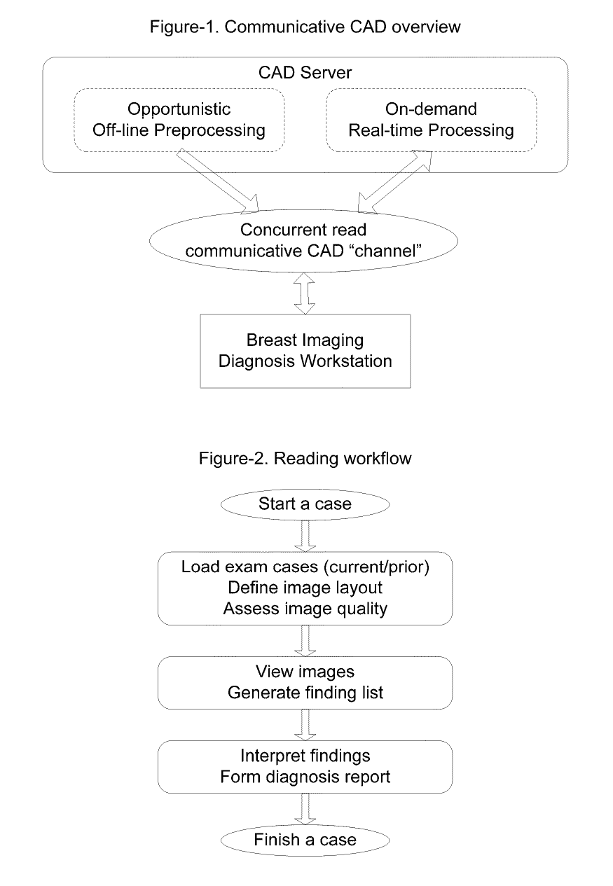

FIG. 1 provides overview to the communicative CAD system.

The apparatus consists of a CAD server, CAD workstation and communication channel between the server and workstation. The CAD server conceptually includes two types of processing: opportunistic preprocessing (off-line) and on-demand processing (real-time).

The off-line CAD processing generates CAD findings. In order to reduce distraction to human readers when using CAD findings, the off-line CAD performance is selected to operate at a performance point similar to average human reader, in particular, at a much higher specificity than current commercial CAD systems can provide: for example, 70% sensitivity with 70% specificity (the best current specificity for commercial product is around 40%). So with much fewer false positive markers, instead of being used as a second read, CAD can play a role in concurrent reading. The off-line CAD processing also generates breast tissue segmentation and density assessment, pectoral muscle segmentation in the MLO views, and nipple position information.

The real-time CAD processing provides more CAD information to readers during image review on workstation. The CAD information can be lesion's segmentations, BI-RADS descriptor measurements and BI-RADS assessment to the findings from CAD and human readers.

FIG. 2 provides the reading workflow with the system.

The workflow followed when making a diagnosis on a workstation consists of three phases: (1) loading and layout of the cases (including the current exam plus the prior or baseline exam) and quality checks; (2) viewing of the images (as well as clinical meta data) and generation of a list of findings; (3) interpretation of the findings that are generated from the viewing phase and from off-line CAD processing, and generation of an assessment report.

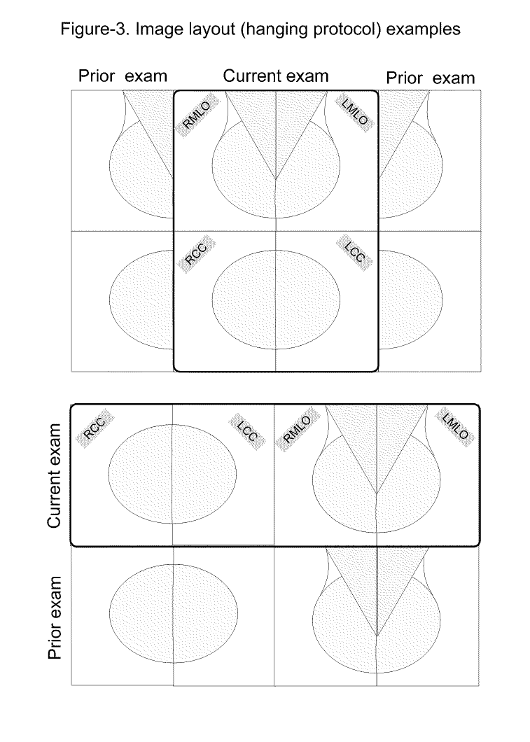

Within the loading and layout phase, the computer helps by: generating segmentations for the breast and the pectoral muscle, and the location of the nipple in each view. These segmentations are then used to clip out artifacts and to layout view images for viewing—chest wall to chest wall (see FIG. 3).

Within the quality check step, the computer helps to determine whether the images are of diagnostic quality with regard to positioning, exposure, and motion. Poor image quality or improper positioning often results in diagnostic errors.

When a prior exam is available, each image can be placed next to its counter-part from the current exam, either to the right/left or above/below. This convention helps systematic viewing of mammographic images.

FIG. 3 provides two mammography image layout (hanging protocol) examples.

When prior exam is available, their images can be places next to its counter-part image from the current exam, either right/left or above/below. This will help systematic viewing of mammographic images.

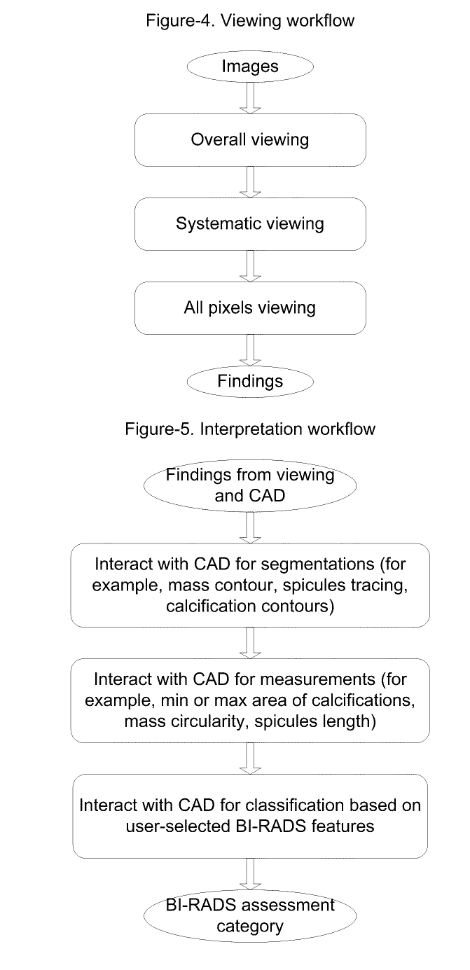

FIG. 4 provides the viewing workflow with the system.

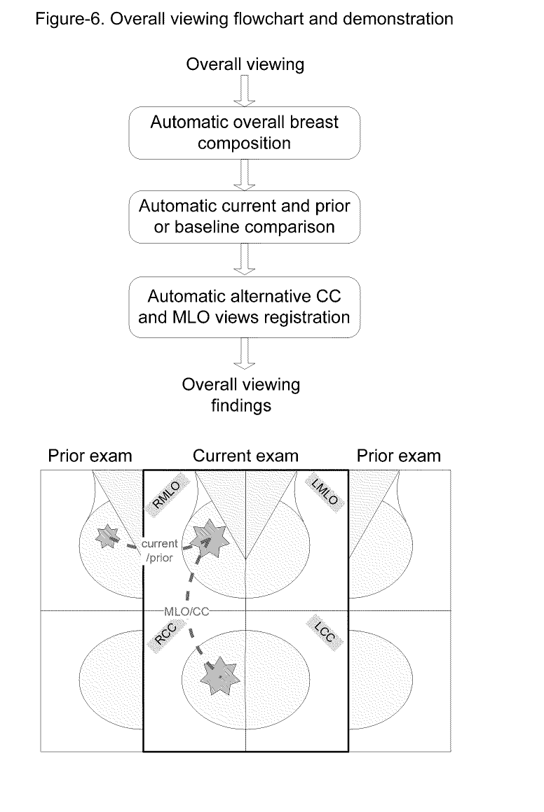

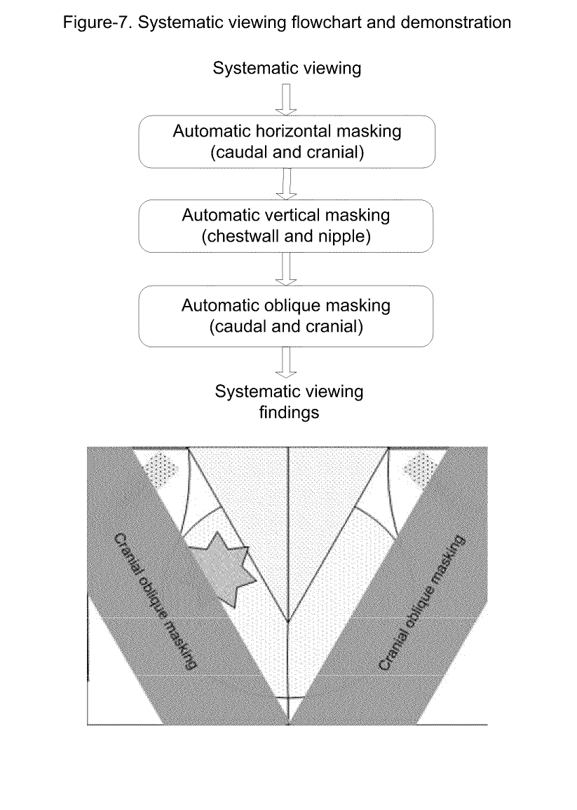

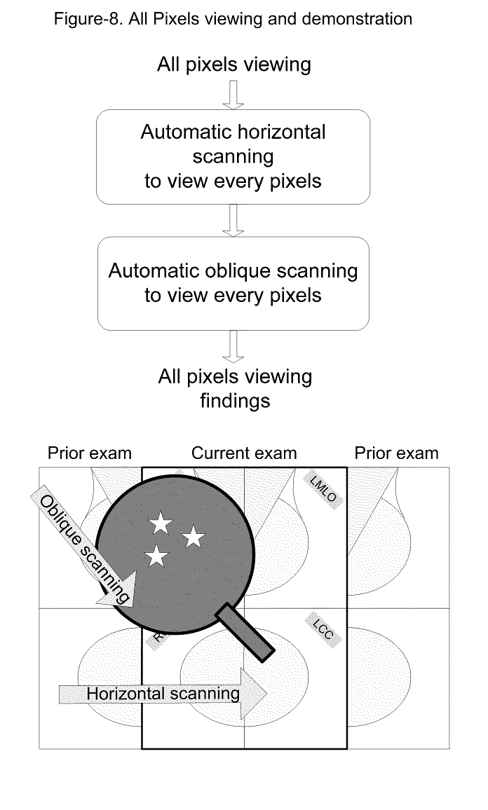

The viewing workflow on workstation includes overall viewing, systematic perception viewing and all pixels magnify glass viewing. The details for each viewing technique are described in FIG. 6, FIG. 7 and FIG. 8.

Overall viewing of current and prior views enhances the detection of tissue density changes; and overall viewing of CC and MLO views enforces the detection on both view projections. FIG. 6 provides the overall viewing flowchart and its demonstration.

A detailed systematic perception comparison of left and right breasts using area masking enhances the detection of structural asymmetries. FIG. 7 provides the systematic (perception) viewing flowchart and its demonstration.

Viewing with electronic magnifying glasses scanning through all pixels in the image enhances the detection of microcalcifications. FIG. 8 provides all pixels viewing and its demonstration.

FIG. 5 provides the interpretation workflow with the system.

As shown in FIG. 5, in a concurrent read model, the findings from viewing are combined with findings from off-line CAD processing to form a list of findings which is the basis for careful analysis and interpretation. This process includes three steps where the operator interacts with the CAD system in order to: (1) segment calcification or mass density regions and to trace spicules; (2) extract measurements from the findings; (3) make assessments based on BI-RADS features.

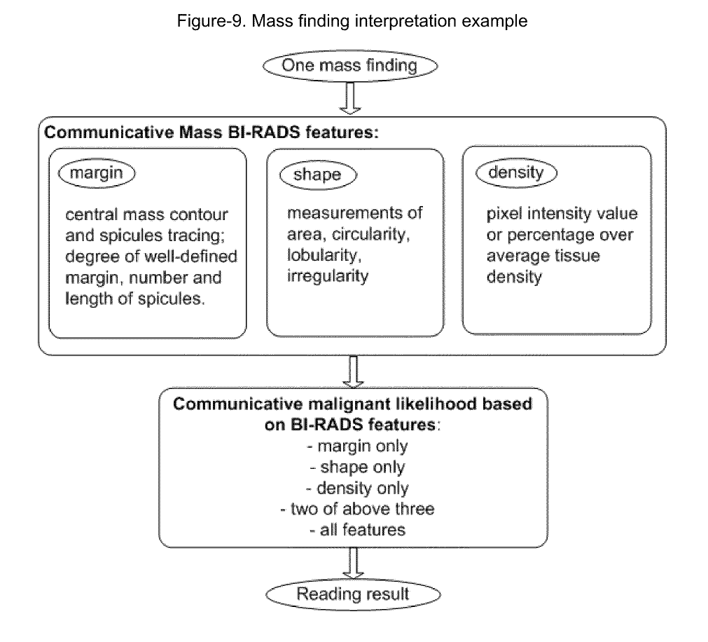

FIG. 9 provides an example of how a mass density finding is assessed.

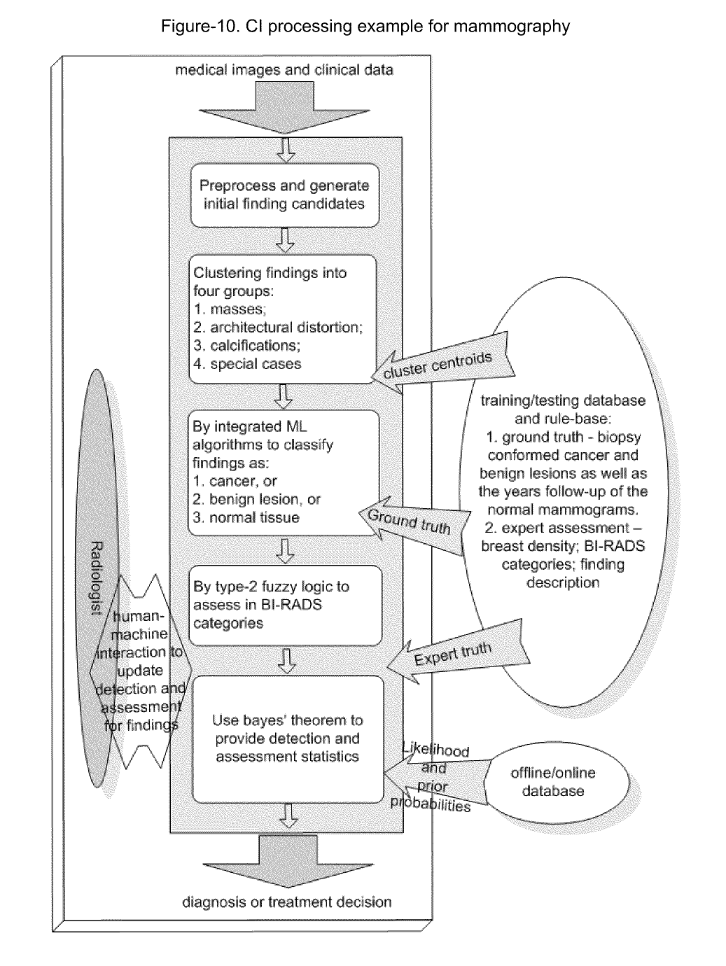

FIG. 10 shows the communicative workflow between a mammographic CAD system and a reader. However the method described here can also be applied to other modality, such as, ultrasound or MRI.

1. In a system that is used interactively by a radiologist in a “concurrent read” model, a method for aiding diagnosis from medical images, comprises:
CAD server
CAD workstation
communication channel between the server and the workstation.

2. The method of claim 1, wherein said the CAD server comprises:
opportunistic off-line preprocessing
on-demand real-time processing

3. The method of claim 2, wherein said the off-line preprocessing, comprises:
generating CAD findings
generating breast tissue segmentation
generating breast density assessment
generating pectoral muscle segmentation in the MLO views
generating the nipple position information

4. The method of claim 2, wherein said the real-time processing, comprises:
calculating the given lesion finding's segmentation
calculating BI-RADS descriptor measurement
calculating BI-RADS assessment

5. The method of claim 4, wherein said the given lesion findings, are:
the CAD findings generated from the off-line preprocessing
the findings prompted by human reader

6. The method of claim 1, wherein said the workstation, the workflow comprises:
loading and layout of the studies (including the current exam plus the prior or baseline exam)
quality checks
viewing of the images (as well as clinical meta data)
generating a list of findings
interpreting the findings that are generated from the viewing phase and from off-line CAD processing
generating an assessment report.

7. The method of claim 6, wherein said, viewing images, comprises:
overall viewing
systematic perception viewing
all pixels magnify glass viewing

8. The method of claim 6, wherein said, interpreting the findings, comprises:
segmenting calcification or mass density findings
tracing spicules of the mass density
extracting measurements of the findings
making assessments based on BI-RADS features

9. The method of claim 7, wherein said, systematic perception viewing, comprises:
left and right breasts using area masking enhances the detection of structural asymmetries

10. The method of claim 7, wherein said, all pixels magnify glass viewing, comprises:
electronic magnifying glasses scanning through all pixels in the image enhances the detection of microcalcifications

11. The method of claim 8, wherein said, extracting measurements of the findings, comprises:
margin features
shape features
density features.

12. The method of claim 8, wherein said, making assessments based on BI-RADS features, comprises:
computing the malignant likelihood based on BI-RADS features, based on
margin feature only
shape feature only
density feature only
two of above three
all features.
